(19) United States
(12) Patent Application Publication
(10) Pub. No.: US 2026/0277147 A1
(43) Pub. Date: Sep. 17, 2026

(54) SHEET POSTPROCESSING APPARATUS THAT PROCESSES PLURALITY OF SHEETS PLACED ON PROCESSING TRAY, AND IMAGE PROCESSING SYSTEM

(71) Applicant: KYOCERA Document Solutions Inc., Osaka (JP)

(72) Inventor: Takuya NISHIMURA, Osaka (JP)

(73) Assignee: KYOCERA Document Solutions Inc., Osaka (JP)

(21) Appl. No.: 19/556,198

(22) Filed: Mar. 4, 2026

(30) Foreign Application Priority Data
Mar. 11, 2025 (JP) 2025-038710

(51) Int. Cl. G03G 15/00

(52) U.S. Cl. CPC G03G 15/6538; G03G 2215/00565; G03G 2215/00599; G03G 2215/00721

(57) ABSTRACT

A sheet postprocessing apparatus restricts, when a plurality of sheets are placed on a processing tray, and a next sheet is switched back by a switchback roller, restricts a pair of cursors from moving, during a period from start of the switchback transport of the next sheet by the switchback roller, to a time that the sheet conducted toward the siding path reaches a prespecified position where the sheet is kept from interfering with the pair of cursors.

### INCORPORATION BY REFERENCE

This application claims priority to Japanese Patent Application No.2025-038710 filed on Mar. 11, 2025, the entire contents of which are incorporated by reference herein.

### BACKGROUND

The present disclosure relates to a sheet postprocessing apparatus that processes a plurality of sheets placed on a processing tray, and an image processing system.

For example, an image forming apparatus reads an image of a document with an image reading device, and forms the image of the document on a sheet, with an image forming device. Then a sheet postprocessing apparatus receives the sheet having the image of the document formed thereon, from the image forming apparatus, and performs postprocessing on the sheet. Examples of the postprocessing performed by the sheet postprocessing apparatus include a stapling operation, for binding the edges of a plurality of sheets, placed on a processing tray and aligned by a pair of cursors, and a sorting operation for delivering sets of the sheets, each including a designated number of sheets, to positions shifted from each other.

A sheet processing device includes a first cursor and a second cursor for aligning the respective side edges of the sheets on the processing tray, and the second sheet is located under the sheet, before the leading edge of the sheet reaches the processing tray, to allow the sheet to pass over the upper side of the second cursor, thereby preventing the sheet from pressing another sheet already placed on the processing tray. The second cursor is moved to a retracted position, deviated from the region under the sheet, when the leading edge of the sheet passes a predetermined position on the second cursor, so that the sheet is placed on the processing tray, and then the respective side edges of the sheets on the processing tray are aligned by the first cursor and the second cursor.

### SUMMARY

The disclosure proposes further improvement of the foregoing technique.

In an aspect, the disclosure provides a sheet postprocessing apparatus including a transport route, a processing tray, a pair of cursors, a cursor moving device, a switchback roller, a control device, and a siding path. Through the transport route, a sheet is transported. The processing tray receives the sheet transported through the transport route. The pair of cursors are provided on respective sides of the processing tray, and opposed to each other in a direction orthogonal to a transport direction of the sheet. The cursor moving device reciprocatively moves the pair of cursors toward and away from each other, and brings the pair of cursors into contact with respective side edges of the sheet on the processing tray, thereby aligning the side edges of the sheet. The switchback roller switches back the sheet delivered to the processing tray. The control device includes a processor, and acts, when the processor executes a control program, as a controller that controls operation of the switchback roller and the cursor moving device. The siding path receives, when the sheet delivered to the processing tray through the transport route is switched back by the switchback roller in a reverse direction, the sheet that has passed the processing tray in the reverse direction. The controller restricts the cursor moving device from moving the pair of cursors, during a period from start of switchback transport of the sheet, to a time that the sheet conducted toward the siding path reaches a prespecified position where the sheet does not interfere with the pair of cursors.

In another aspect, the disclosure provides an image processing system including an image forming apparatus, and the sheet postprocessing apparatus defined above. The image forming apparatus forms an image of a document on a sheet. When a plurality of sheets are sequentially delivered from the image forming apparatus, the controller of the sheet postprocessing apparatus conducts the sheet delivered first to the processing tray through the transport route, conducts the sheet delivered next to the siding path by the switchback transport, and restricts the cursor moving device from moving the pair of cursors, during a period from start of the switchback transport of the sheet, to a time that the sheet conducted toward the siding path reaches a prespecified position where the sheet is kept from interfering with the pair of cursors.

### BRIEF DESCRIPTION OF THE DRAWINGS

FIG. 1 is a cross-sectional view showing an image forming apparatus and a sheet postprocessing apparatus, constituting an image processing system according to an embodiment of the disclosure;

FIG. 2A is an enlarged cross-sectional view showing a main portion of the sheet postprocessing apparatus;

FIG. 2B is an enlarged schematic drawing showing the main portion of the sheet postprocessing apparatus;

FIG. 3 is a perspective view showing a pair of cursors and related parts, in the sheet postprocessing apparatus;

FIG. 4 is a front view showing the pair of cursors and a processing tray;

FIG. 5A, FIG. 5B, and FIG. 5C are a plan view, a side view, and a front view, respectively, schematically showing the pair of cursors and the processing tray;

FIG. 6 is a functional block diagram showing an essential internal configuration of the image forming apparatus and the sheet postprocessing apparatus;

FIG. 7A is a schematic plan view showing the cursors set at a standby position, most distant from each other;

FIG. 7B is a schematic side view showing a state where an upper delivery roller is moved downward, to be pressed against a lower delivery roller;

FIG. 8A is a schematic plan view showing the cursors set at the standby position, most distant from each other;

FIG. 8B is a schematic side view showing a state where the upper delivery roller is moved upward away from the lower delivery roller, and a sheet is delivered from a transport roller to the processing tray;

FIG. 8C is a schematic plan view showing the cursors aligning respective edges of the sheets;

FIG. 9A is a schematic plan view showing the cursors set at the standby position, most distant from each other;

FIG. 9B is a schematic side view showing a state where the upper delivery roller is moved downward, to be pressed against the lower delivery roller, and the sheet is delivered from the processing tray to an output tray;

FIG. 10A to FIG. 10D are schematic side views showing operations of the transport rollers and the delivery rollers, performed when a next sheet is delivered from the image forming apparatus, while the sheets on the processing tray are subjected to stapling operation at the trailing edge; and

FIG. 11 is a flowchart showing a control process performed by a drive controller of the sheet postprocessing apparatus, to deliver and process the sheet.

### DETAILED DESCRIPTION

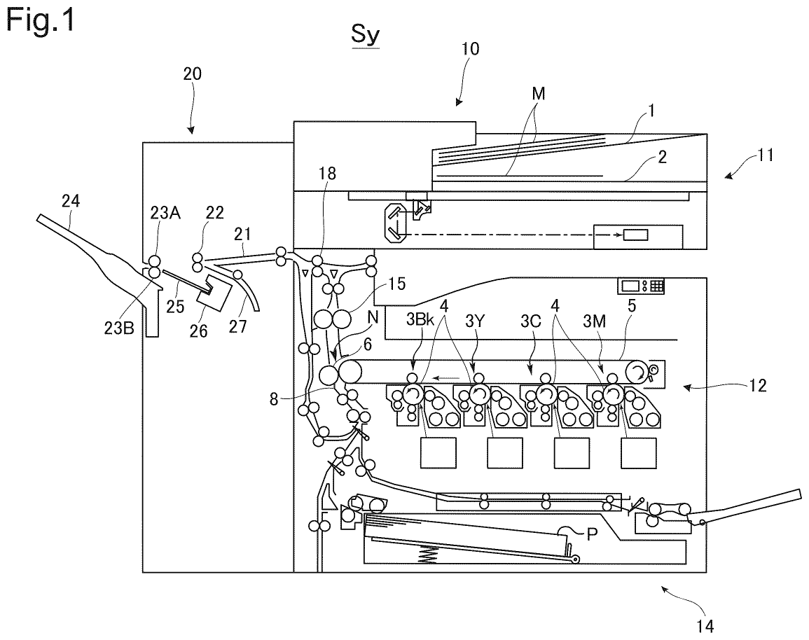

Hereafter, an embodiment of the disclosure will be described, with reference to the drawings. FIG. 1 is a cross-sectional view showing an image forming apparatus and a sheet postprocessing apparatus, constituting an image processing system according to an embodiment of the disclosure. The image processing system Sy according to the embodiment includes the image forming apparatus 10 that reads an image of a document and forms the image on a sheet, and the sheet postprocessing apparatus 20 that receives the sheet from the image forming apparatus 10, and performs postprocessing on the sheet.

The image forming apparatus 10 includes an image reading device 11 and an image forming device 12. The image reading device 11 reads respective images of a plurality of documents with an image sensor, while the documents are sequentially drawn out from a document tray 1 and transported, and sequentially delivers the documents to a discharge tray 2 to stack thereon. The analog output from the image sensor, representing the image of each of the documents, is converted to a digital signal, and image data representing the image of the document is generated.

The image forming device 12 prints the image represented by the image data on a sheet, each time the image data representing images of a plurality of documents is sequentially inputted. The image forming device 12 includes an image forming unit 3M for magenta, an image forming unit 3C for cyan, an image forming unit 3Y for yellow, and an image forming unit 3Bk for black. In each of the image forming units 3M, 3C, 3Y, and 3Bk, the surface of a photoconductor drum 4 is uniformly charged and exposed, to thereby form an electrostatic latent image on the surface of the photoconductor drum 4, and then the electrostatic latent image on the surface of the photoconductor drum 4 is developed into a toner image, which is transferred to an intermediate transfer belt 5. As result, a colored toner image is formed on the intermediate transfer belt 5. The colored toner image is transferred, as secondary transfer, to the sheet P transported from a sheet feeding device 14 through a transport route 8, at a nip region N between the intermediate transfer belt 5 and a secondary transfer roller 6.

The images of the respective documents are sequentially formed on the sheets P by the image forming device 12, and the sheets P are sequentially heated and pressed by the fixing device 15, so that the toner images are fixed onto the corresponding sheets P by thermal compression. The sheets P are sequentially transported to the sheet postprocessing apparatus 20, via a transport roller 18.

The sheet postprocessing apparatus 20 receives the sheet P from the image forming apparatus 10, and guides the sheet P through a transport route 21 to a pair of transport rollers 22 and a pair of delivery rollers 23A and 23B. Then the sheet P is delivered to an output tray 24 through the delivery rollers 23A and 23B, or received by a processing tray 25 via the transport rollers 22, to be subjected to a stapling operation performed by a stapling device 26 on the trailing edge of the sheets P on the processing tray 25, and the sheets P that have undergone the stapling operation are drawn out from the processing tray 25 by the delivery rollers 23A and 23B, and delivered to the output tray 24.

On the side of the sheet postprocessing apparatus 20, when a next sheet P is delivered from the image forming apparatus 10, while the stapling operation is being performed on the trailing edge of the sheets P on the processing tray 25, the transport of the next sheet by the transport rollers 22 is stopped halfway, and the transport rollers 22 are made to rotate reversely, so that the next sheet is transported in the reverse direction (switchback transport) over the processing tray 25 by the transport rollers 22, and delivered to a siding path 27 to be retained therein. When the sheets P subjected to the stapling operation are drawn out from the processing tray 25 by the delivery rollers 23A and 23B, and delivered to the output tray 24, the next sheet is drawn out from the siding path 27 by the transport rollers 22, and delivered to the processing tray 25.

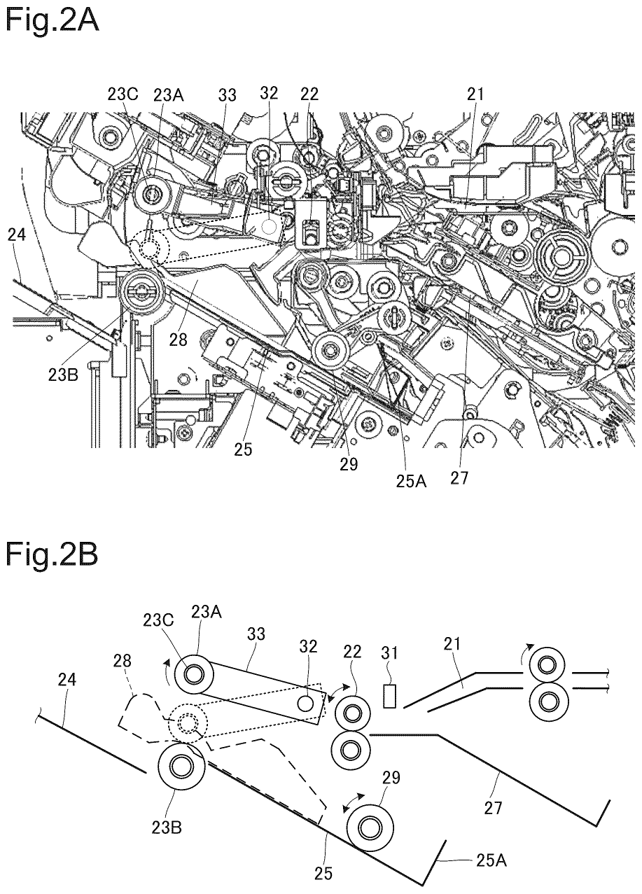

FIG. 2A is an enlarged cross-sectional view showing a main portion of the sheet postprocessing apparatus 20, and FIG. 2B is an enlarged schematic drawing showing the main portion of the sheet postprocessing apparatus 20. As shown in FIG. 2A and FIG. 2B, the sheet postprocessing apparatus 20 includes the transport route 21, the transport rollers 22, the delivery rollers 23A and 23B, the output tray 24, the processing tray 25, the stapling device 26 (see FIG. 1), and the siding path 27, as described above, and also a pair of cursors 28 that align the respective side edges of the sheets P on the processing tray 25, an auxiliary roller 29 that biases the sheet P on the processing tray 25 so as to move in the direction opposite to a transport direction A, and a sheet sensor 31 located upstream of the transport rollers 22 in the transport direction A of the sheet P, to detect the trailing edge of the sheet P just about to pass through the transport rollers 22.

As shown in FIG. 2A and FIG. 2B, the delivery roller 23A on the upper side can be moved in the up-down direction, to be in contact with or spaced from the delivery roller 23B on the lower side. For example, a drive shaft 23C of the delivery roller 23A on the upper side is supported at the distal end portion of a pivotal arm 33, set to pivot about a pivotal shaft 32, so that, when the pivotal arm 33 is made to pivot up or downward, the delivery roller 23A on the upper side is made to contact or move away from the delivery roller 23B on the lower side.

The auxiliary roller 29 is also made to contact or move away from the processing tray 25, with a structure similar to that of the delivery roller 23A on the upper side. The auxiliary roller 29 contacts the sheet P on the processing tray 25 so as to bias the sheet P downward, thereby making the sheet P abut against an abutment wall 25A provided at the lower end of the processing tray 25, to be retained at that position.

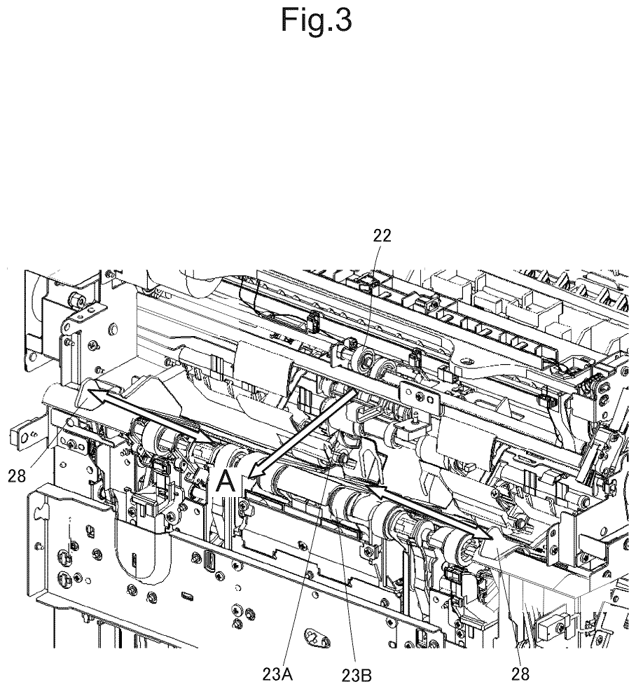

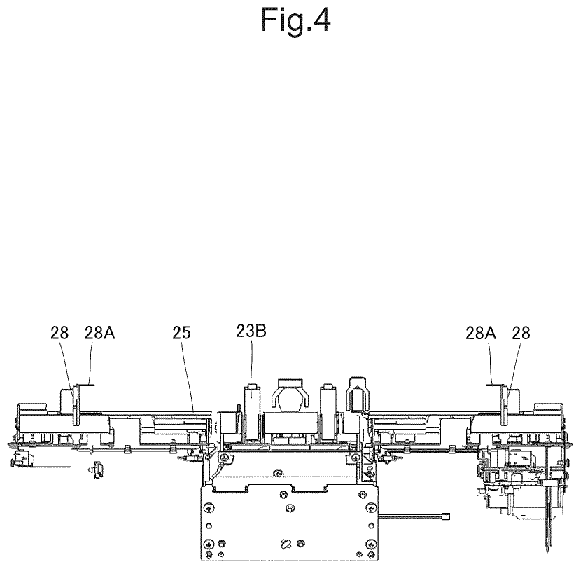

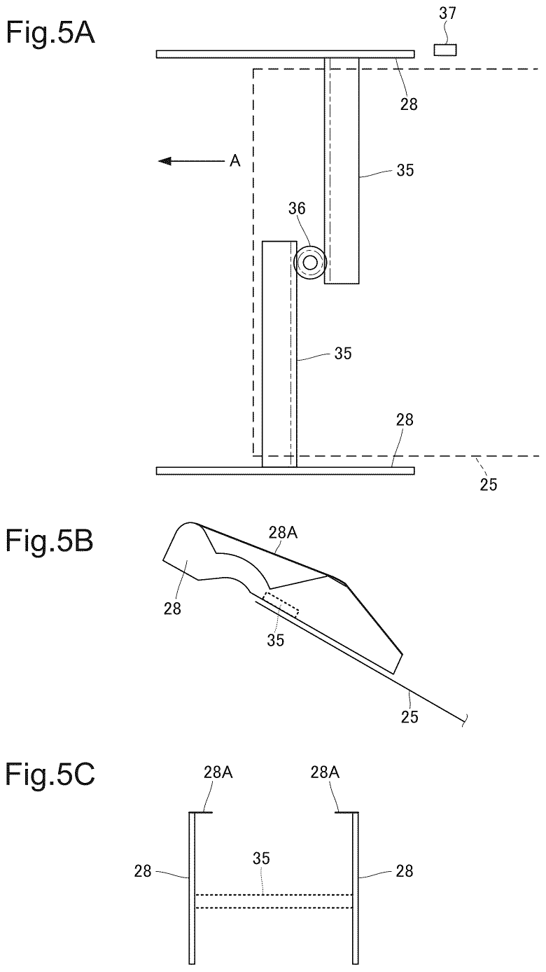

FIG. 3 is a perspective view showing a pair of cursors 28 and related parts. FIG. 4 is a front view showing the pair of cursors 28 and the processing tray 25. FIG. 5A, FIG. 5B, and FIG. 5C are a plan view, a side view, and a front view, respectively, schematically showing the pair of cursors 28 and the processing tray 25.

As shown in FIG. 3, FIG. 4, FIG. 5A, FIG. 5B, and FIG. 5C, the pair of cursors 28 are located on the respective sides of the processing tray 25, and opposed to each other in the direction orthogonal to the transport direction A of the sheet P. The cursors 28 are movable back and forth, toward and away from each other. For example, a stepping motor is employed as a drive source of the cursors 28. In addition, a mechanism is provided that converts the rotation of the stepping motor to linear movement in the direction to move the cursors 28 toward and away from each other. This is a known mechanism including rack gears 35 connected to the respective cursors 28, and projecting toward the opposite cursor 28, the rack gears 35 movably extending parallel to each other, and a pinion gear 36 located between the rack gears 35 so as to be meshed with the respective rack gears 35. When the pinion gear 36 is made to rotate in the forward direction or reverse direction, the rack gears 35 are made to move so as to pass by each other, by which the cursors 28 are made to move toward or away from each other. The pinion gear 36 can be made to rotate in the forward direction or reverse direction by the stepping motor. The rotation direction and rotation angle of the stepping motor is controlled, to move the cursors 28 to a standby position where the cursors 28 are most distant from each other, on the basis of a detection output from a cursor sensor 37 that detects the standby position, and then to move the cursors 28 toward each other from the standby position, by a distance according to the width of the sheet P, thereby allowing the cursors 28 to align the respective side edges of the sheets P on the processing tray 25.

Here, the mechanism that moves the cursors 28 toward and away from each other is not limited to the mentioned one, and a different mechanism may be employed. For example, the pinion gear 36 may be provided for each of the sets of the cursor 28 and the rack gear 35, and the pinion gears 36 may each be connected to the stepping motor. In this case, the cursors 28 can be made to move toward or away from each other, by controlling the rotation direction and rotation angle of each stepping motor.

The cursors 28 each include an eaves-shaped guide 28A, provided on the upper edge. The eaves-shaped guide 28A is formed of a thin plate, so as to protrude in the width direction of the sheet toward the opposite cursor 28, and has a dogleg shape, for example when viewed in a lateral direction from a position on the downstream side in the sheet transport direction. When the cursors 28 are in contact with the respective side edges of the sheet P, the clearance between the eaves-shaped guides 28A of the cursors 28 is narrower than the width of the sheet P, and therefore the sheet P slides over the eaves-shaped guides 28A of the cursors 28.

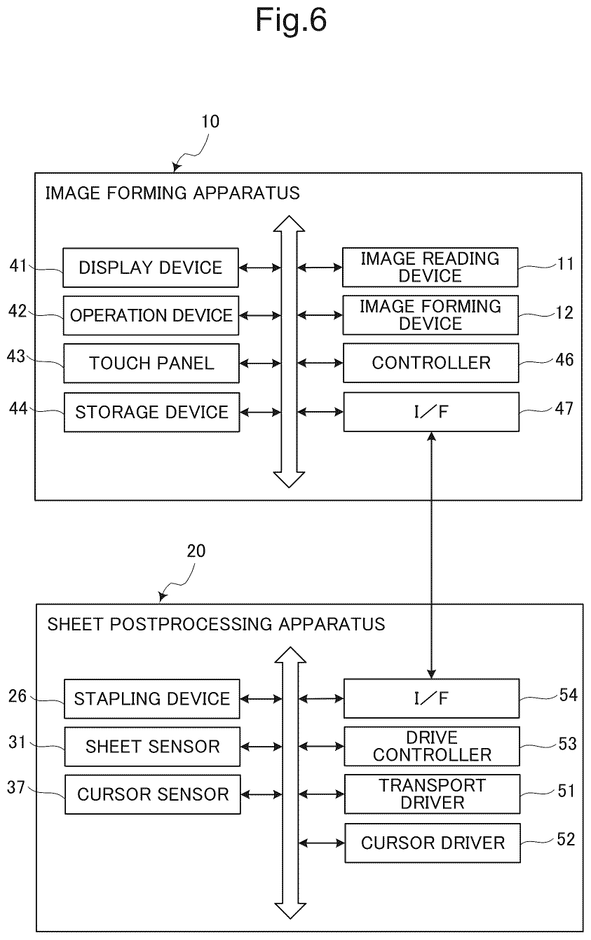

Hereunder, a configuration related to the control of the image forming apparatus 10 and the sheet postprocessing apparatus 20 will be described. FIG. 6 is a block diagram showing an essential internal configuration of the image forming apparatus 10 and the sheet postprocessing apparatus 20. As shown in FIG. 6, the image forming apparatus 10 includes the image reading device 11, the image forming device 12, a display device 41, an operation device 42, a touch panel 43, a storage device 44, a controller 46, and an interface 47. The cited components are configured to transmit and receive data and signals to and from each other, via a bus.

The display device 41 is, for example, constituted of a liquid crystal display (LCD) or an organic light-emitting diode (OLED) display.

The operation device 42 includes physical keys such as a numeric keypad, an enter key, and a start key.

A touch panel 43 is overlaid on the screen of the display device 41. The touch panel 43 is based on what is known as a resistive film or electrostatic capacitance, and detects a contact (touch) of the user's finger made thereon, along with the touched position, and outputs a detection signal indicating the coordinate of the touched position, to the controller 46.

The storage device 44 is a large-capacity storage device such as a solid-state drive (SSD) or a hard disk drive (HDD), and contains various application programs and various types of data.

The controller 46 includes a processor, a random-access memory (RAM), a read-only memory (ROM), and so forth. The processor is, for example, a central processing unit (CPU), an application specific integrated circuit (ASIC), or a micro processing unit (MPU), and acts as a processor that executes the programs stored in the ROM or storage device 44, thereby executing various types of processings necessary for the image forming operation by the image forming apparatus 10.

The controller 46 is connected to the image reading device 11, the image forming device 12, the display device 41, the operation device 42, the touch panel 43, the storage device 44, and the interface 47. The controller 46 controls the operation of the components cited above, and transmits and receives signals and data to and from those components.

The controller 46 also controls the displaying operation of the display device 41. In addition, the controller 46 receives operation instructions inputted by the user, on the basis of a detection signal outputted from the touch panel 43, or operation of physical keys on the operation device 42. For example, the controller 46 receives a touch operation, through the touch panel 43, performed on a graphical user interface (GUI) displayed on the screen of the display device 41.

Further, the sheet postprocessing apparatus 20 includes a stapling device 26, a sheet sensor 31, a cursor sensor 37, a transport driver 51, a cursor driver 52, a drive controller 53, and an interface 54. The cited components are configured to transmit and receive data and signals to and from each other, via a bus.

The transport driver 51 includes a motor, a clutch, and a gear unit for rotating the transport rollers 22, the delivery rollers 23A and 23B, and the auxiliary roller 29. The transport driver 51 also includes an actuator that moves the upper delivery roller 23A toward and away from the lower delivery roller 23B. The transport driver 51 and the transport rollers 22 exemplify the switchback roller according to the disclosure.

The cursor driver 52 includes the stepping motor that rotates the pinion gear 36 shown in FIG. 5A, and moves the cursors 28 back and forth toward and away from each other. The cursor driver 52 and the pinion gear 36 exemplify the cursor moving device according to the disclosure.

The sheet sensor 31 is, for example, a reflective optical sensor including a light emitting element and a photodetector, and detects the trailing edge of the sheet P just about to pass through the transport rollers 22.

The cursor sensor 37 is, for example, a reflective optical sensor, and detects the standby position where the cursors 28 are most distant from each other.

The drive controller 53 includes a processor, a RAM, and a ROM, and executes control programs stored in the ROM, thereby controlling the transport driver 51 to rotate the transport rollers 22, the delivery rollers 23A and 23B, and the auxiliary roller 29, to move the upper delivery roller 23A toward and away from the lower delivery roller 23B, controlling the rotation direction and rotation angle of the stepping motor of the cursor driver 52, to move the cursors 28 toward and away from each other, and controlling the stapling device 26 to perform the stapling operation on the trailing edge of the sheets P on the processing tray 25. The drive controller 53 exemplifies the controller according to the disclosure.

The drive controller 53 also decides, on the basis of the detection output from the sheet sensor 31, the detection timing of the sheet P just about to reach the transport rollers 22, and the detection timing of the trailing edge of the sheet P just about to pass through the transport rollers 22.

Further, the drive controller 53 decides that the cursors 28 are located at the standby position most distant from each other, on the basis of the detection output from the cursor sensor 37.

The controller 46 of the image forming apparatus 10 and the drive controller 53 of the sheet postprocessing apparatus 20 input and output control signals to and from each other, via the respective interfaces 47, 54. For example, the controller 46 of the image forming apparatus 10 outputs, before transporting the sheet P to the sheet postprocessing apparatus 20, the control signal indicating, for example, whether the processing by the sheet postprocessing apparatus 20 is necessary, the size (length and width) of the sheet P, and the number of sheets P to be processed, to the drive controller 53 of the sheet postprocessing apparatus 20. The drive controller 53 of the sheet postprocessing apparatus 20 controls the operation of the transport driver 51 and the cursor driver 52 according to such control signal, to process the sheet P delivered from the image forming apparatus 10.

For the image processing system Sy configured as above, the user can, for example, set a plurality of documents on the document tray 1 of the image reading device 11, and input an instruction indicating whether the sheet P has to be processed, by operating, through the touch panel 43, the GUI displayed on the screen of the display device 41, and then press the start key. Accordingly, the operation device 42 receives the instruction indicating whether the sheet P has to be processed.

When the operation device 42 receives the instruction indicating whether the sheet P has to be processed, the controller 46 of the image forming apparatus 10 outputs the control signal indicating the size of the sheet P, and the number of sheets P to be processed, to the sheet postprocessing apparatus 20 via the interface 47. Then the image forming apparatus 10 causes the image reading device 11 to sequentially read the images of the respective documents, causes the image forming device 12 to sequentially form the images on the respective sheets P, and transports the sheets P to the sheet postprocessing apparatus 20.

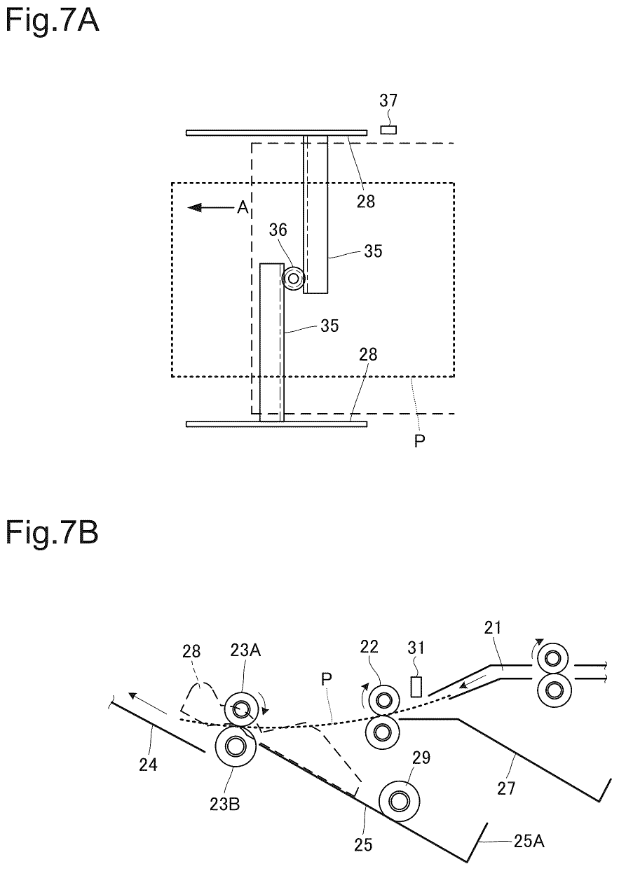

When the control signal indicating that the processing of the sheet P is unnecessary is inputted via the interface 54, the drive controller 53 of the sheet postprocessing apparatus 20 controls the cursor driver 52, on the basis of the detection output from the cursor sensor 37, to move the cursors 28 to the standby position most distant from each other as shown in FIG. 7A, and controls the transport driver 51, to move the upper delivery roller 23A downward, so as to be pressed against the lower delivery roller 23B as shown in FIG. 7B, and to rotate the transport rollers 22 and the delivery rollers 23A and 23B. The sheet P is transported by the transport rollers 22, reaches the delivery rollers 23A and 23B through between the cursors 28 on the respective sides of the processing tray 25, and is delivered to the output tray 24 through the delivery rollers 23A and 23B.

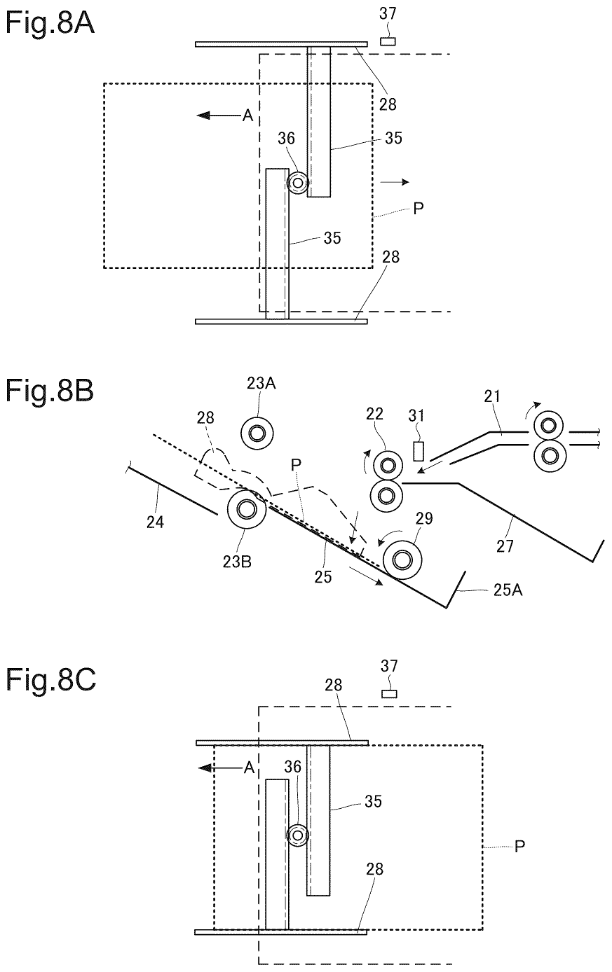

When the control signal indicating that the sheet P has to be processed, the size of the sheet P, and the number of sheets P to be processed, is inputted, the drive controller 53 of the sheet postprocessing apparatus 20 controls the cursor driver 52, on the basis of the detection output from the cursor sensor 37, to move the cursors 28 to the standby position most distant from each other as shown in FIG. 8A, and controls the transport driver 51, to move the upper delivery roller 23A upward, so as to be spaced from the lower delivery roller 23B as shown in FIG. 8B, to stop the rotation of the delivery rollers 23A and 23B, to rotate the transport rollers 22, to bring the auxiliary roller 29 close to the processing tray 25, and to rotate the auxiliary roller 29. The sheet P is transported by the transport rollers 22, and reaches the delivery rollers 23A and 23B through between the cursors 28 on the respective sides of the processing tray 25, but is received by the processing tray 25 through the transport rollers 22, instead of being transported by the delivery rollers 23A and 23B. Since the processing tray 25 is inclined, the sheet P slides downward on the processing tray 25. The sheet P reaches the auxiliary roller 29, and is further moved by the auxiliary roller 29, to be abutted against the abutment wall 25A at the lower end of the processing tray 25, and then stops at that position.

When the sheets P of the designated number according to the control signal are accumulated on the processing tray 25, the drive controller 53 of the sheet postprocessing apparatus 20 controls the transport driver 51, to move the auxiliary roller 29 away from the processing tray 25, and controls the cursor driver 52, to move the cursors 28 from the standby position toward each other, by a distance determined by the size (width) of the sheet P indicated by the control signal, as shown in FIG. 8C, so that the cursors 28 align the respective side edges of the sheets P on the processing tray 25. Then the drive controller 53 controls the stapling device 26, to perform the stapling operation on the trailing edge of the sheets P on the processing tray 25.

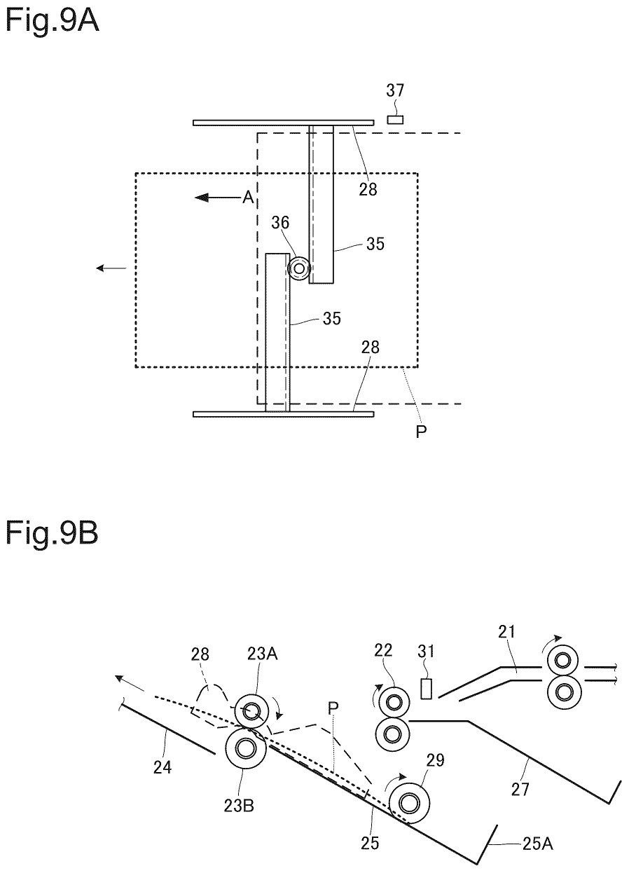

The drive controller 53 controls the cursor driver 52, on the basis of the detection output from the cursor sensor 37, to move the cursors 28 to the standby position most distant from each other as shown in FIG. 9A, and controls the transport driver 51, to move the upper delivery roller 23A downward, so as to be pressed against the lower delivery roller 23B as shown in FIG. 9B, so that the leading edges of the sheets P that have been subjected to the stapling operation are pinched between the delivery rollers 23A and 23B, to rotate the delivery rollers 23A and 23B, and to bring the auxiliary roller 29 close to the processing tray 25 and rotate the auxiliary roller 29 in the reverse direction, to deliver the sheets P to the output tray 24.

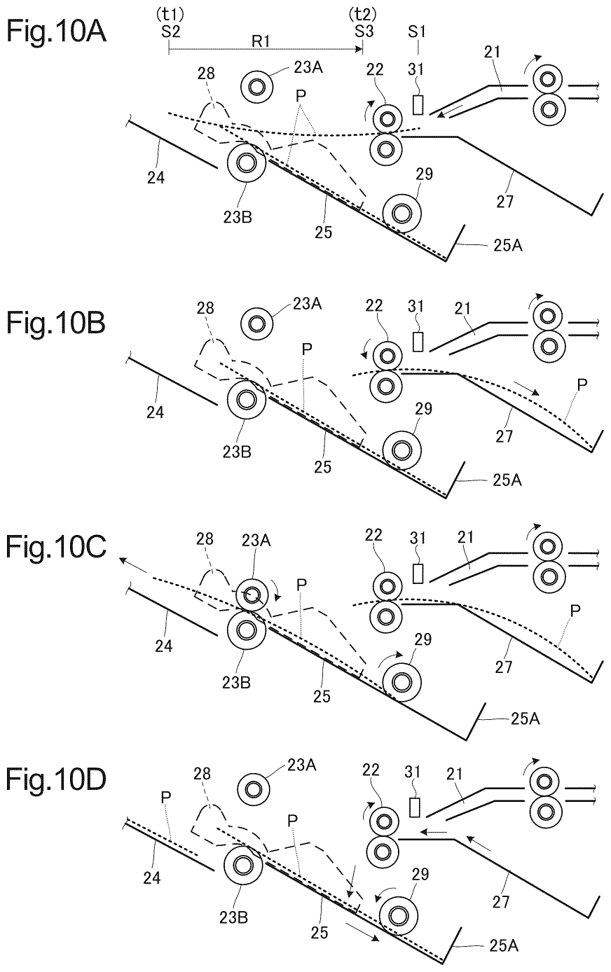

In the sheet postprocessing apparatus 20, further, when a next sheet P is delivered from the image forming apparatus 10, while the stapling operation is being performed on the trailing edge of the sheets P on the processing tray 25, the drive controller 53 controls the transport driver 51, at the timing that the sheet sensor 31 has detected the trailing edge of the next sheet P just about to pass through the transport rollers 22, to temporarily stop the transport rollers 22, to move the upper delivery roller 23A away from the lower delivery roller 23B and stop the delivery rollers 23A and 23B as shown in FIG. 10A, and to rotate the transport rollers 22 in the reverse direction as shown in FIG. 10B, so that the next sheet P is switched back to the siding path 27, and retained therein. Then the drive controller 53 controls the transport driver 51, to press the upper delivery roller 23A against the lower delivery roller 23B as shown in FIG. 10C, so that the leading edges of the sheets P that have been subjected to the stapling operation are pinched between the delivery rollers 23A and 23B, to rotate the delivery rollers 23A and 23B, and to bring the auxiliary roller 29 close to the processing tray 25 and rotate the auxiliary roller 29 in the reverse direction, to deliver the sheets P to the output tray 24. Further, the drive controller 53 controls the transport driver 51, to move the upper delivery roller 23A away from the lower delivery roller 23B and stop the delivery rollers 23A and 23B as shown in FIG. 10D, and to rotate the transport rollers 22, so that the transport rollers 22 draw out the next sheet from the siding path 27, and deliver to the processing tray 25.

Now, in the case where, while the sheets P are accumulated on the processing tray 25, and the cursors 28 are being moved toward each other as shown in FIG. 8C, the next sheet P is delivered and switched back by the transport rollers 22 as shown in FIG. 10A and FIG. 10B, the next sheet contacts at least one of the cursors 28 moving toward each other, and switched back in a skewed posture, thus to be retained in the siding path 27 in the skewed posture. When such next sheet P is largely skewed, although the transport rollers 22 draw out the next sheet P from the siding path 27 and deliver to the processing tray 25 as shown in FIG. 10D, and the cursors 28 are moved toward each other so as to contact the respective side edges of the next sheet P, the cursors 28 are unable to properly align the respective side edges of the next sheet P.

In this embodiment, accordingly, the drive controller 53 of the sheet postprocessing apparatus 20 restricts the cursors 28 from moving, during a period between a start time t1 of the switchback transport of the next sheet P by the transport rollers 22, and an arrival time t2 that the leading edge of the next sheet P conducted to the siding path 27 reaches a prespecified position S3 (see FIG. 10A), where the sheet P is kept from interfering with the cursor 28. The prespecified position S3, where the sheet P being switched back is kept from interfering with the cursor 28, is determined in advance, for example through experiments.

For example, the drive controller 53 of the sheet postprocessing apparatus 20 temporarily stops the transport rollers 22 transporting the next sheet P, at the timing that the sheet sensor 31 has detected the trailing edge of the next sheet P just about to pass through the transport rollers 22 as shown in FIG. 10A, and then starts the switchback transport of the next sheet P. Therefore, the timing that the sheet sensor 31 has detected the trailing edge of the next sheet P is regarded as the start time t1 of the switchback transport of the next sheet P. In addition, the drive controller 53 defines the position of the trailing edge of the next sheet P, at the start time t1 of the switchback transport of the sheet P, as a known position S1 of the sheet sensor 31, and calculates a leading edge position S2 of the next sheet P at the start time t1 of the switchback transport, by adding the length of the next sheet P (size of the sheet P indicated by the control signal) to the trailing edge position S1. Then the drive controller 53 calculates a distance R1 between the leading edge position S2 of the next sheet P and the prespecified position S3 where the leading edge of the next sheet P is kept from interfering with the cursor 28, calculates a transport time Th by dividing the distance R1 by predetermined speed of the switchback transport, and defines the time point that the transport time Th has elapsed after the start time t1 of the switchback transport of the sheet P, as the arrival time t2. The drive controller 53 restricts the cursors 28 from moving toward each other as shown in FIG. 8C, during the period between the start time t1 of the switchback transport of the next sheet, and the arrival time t2 that the leading edge of the next sheet P reaches the prespecified position S3, where the sheet P is kept from interfering with the cursor 28.

The mentioned arrangement prevents the next sheet P from contacting at least one of the cursors 28 moving toward each other, and being switched back in a skewed posture.

As described above, the trailing edge position of the next sheet P is set as the known position of the sheet sensor 31, and the drive controller 53 calculates the leading edge position S2 of the next sheet P by adding the length of the next sheet P (size of the sheet P indicated by the control signal) to the trailing edge position S1 of the next sheet P. Accordingly, the distance R1 between the leading edge position S2 of the next sheet P and the prespecified position S3 is determined according to the length of the next sheet P, and the transport time Th, obtained by dividing the distance R1 by the speed of the switchback transport, is also determined according to the length of the next sheet P. Therefore, the transport time Th may be calculated in advance, with respect to each of the lengths (sizes) of various sheets, and stored in a non-illustrated memory of the sheet postprocessing apparatus 20, in association with the corresponding length of the sheet. In this case, the drive controller 53 retrieves and acquires the transport time Th corresponding to the length of the next sheet P from the memory, and sets the time point that the acquired transport time Th has elapsed, after the start time t1 of the switchback transport of the next sheet P, as the arrival time t2, and then restricts the cursors 28 from moving toward each other, curing the period between the start time t1 and the arrival time t2.

Alternatively, depending on the location of the sheet sensor 31 that detects the leading edge and the trailing edge of the sheet P, a different method may be adopted to calculate the distance R1 between the leading edge position S2 of the next sheet P and the prespecified position S3, the transport time Th, and the arrival time t2.

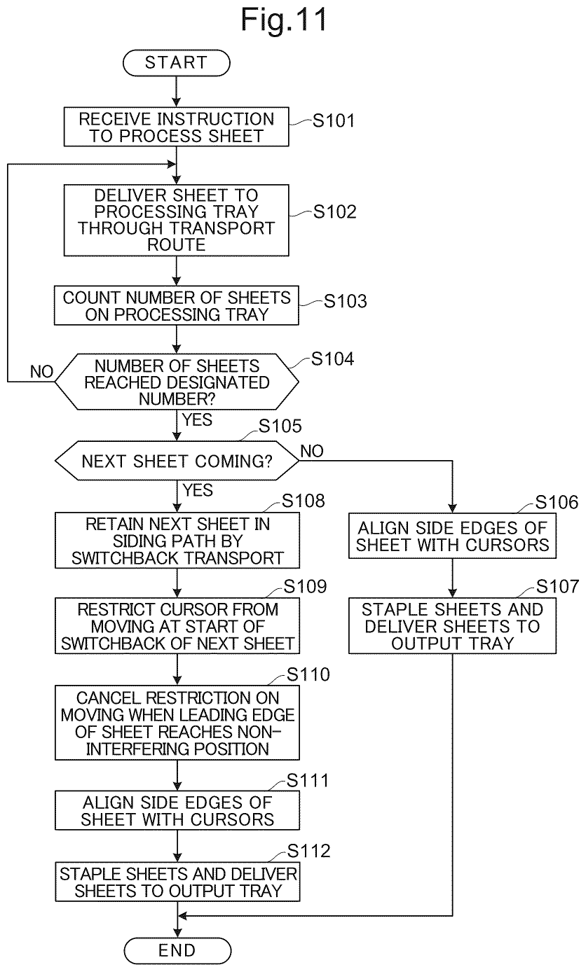

FIG. 11 is a flowchart showing a control process performed by the drive controller 53 of the sheet postprocessing apparatus 20, to deliver and process the sheet.

The drive controller 53 of the sheet postprocessing apparatus 20 decides that the processing of the sheet P has been instructed, according to the control signal inputted from the image forming apparatus 10 via the interface 54 (S101). The drive controller 53 controls the cursor driver 52, on the basis of the detection output from the cursor sensor 37, to move the cursors 28 to the standby position most distant from each other as shown in FIG. 8A, and controls the transport driver 51, to move the upper delivery roller 23A upward, so as to be spaced from the lower delivery roller 23B as shown in FIG. 8B, and to stop the rotation of the delivery rollers 23A and 23B. Then the controller 53 rotates the transport rollers 22 to deliver the sheet P to the processing tray 25, and makes the sheet P abut against the abutment wall 25A of the processing tray 25, using the auxiliary roller 29 (S102).

The drive controller 53 of the sheet postprocessing apparatus 20 counts, on the basis of the detection output from the sheet sensor 31, the number of sheets P that have been delivered to the processing tray 25 through the transport rollers 22 (S103). Since the number of sheets P to be processed is designated by the control signal, the drive controller 53 decides whether the counted number of sheets has reached the designated number of sheets P to be processed (S104). In the case where the counted number of sheets has not reached the designated number of sheets P to be processed (NO at S104), the drive controller 53 repeats the operation of S102 and S103. Accordingly, each time the sheet P is delivered from the image forming apparatus 10 to the sheet postprocessing apparatus 20, the sheet P is delivered to the processing tray 25 through the transport rollers 22.

When the counted number of sheets reaches the designated number of sheets P to be processed (YES at S104), the drive controller 53 of the sheet postprocessing apparatus 20 decides whether a next sheet P, to be subjected to the stapling operation, is to be delivered, on the basis of the control signal (S105).

For example, upon deciding that the next sheet P to be subjected to the stapling operation is not to be delivered (NO at S105), the drive controller 53 of the sheet postprocessing apparatus 20 controls the transport driver 51, to move the auxiliary roller 29 to move away from the processing tray 25, and controls the cursor driver 52, to move the cursors 28 to move from the standby position toward each other, by the distance determined by the width of the sheet P, as shown in FIG. 8C, so that the cursors 28 align the respective side edges of the sheets P on the processing tray 25 (S106), and then controls the stapling device 26, to perform the stapling operation on the trailing edge of the sheets P on the processing tray 25. Then the drive controller 53 controls the cursor driver 52, on the basis of the detection output from the cursor sensor 37, to move the cursors 28 to the standby position most distant from each other as shown in FIG. 9A, and controls the transport driver 51, to move the upper delivery roller 23A downward, so as to be pressed against the lower delivery roller 23B as shown in FIG. 9B, so that the leading edges of the sheets P that have been subjected to the stapling operation are pinched between the delivery rollers 23A and 23B, to rotate the delivery rollers 23A and 23B, and to rotate the auxiliary roller 29 in the reverse direction, to deliver the sheets P subjected to the stapling operation to the output tray 24 (S107).

In contrast, upon deciding that the next sheet P to be subjected to the stapling operation is to be delivered (YES at S105), the drive controller 53 of the sheet postprocessing apparatus 20 retains the cursors 28 in the standby position, and controls the transport driver 51, when the sheet sensor 31 detects the trailing edge of the next sheet P, to rotate the transport rollers 22 in the reverse direction after once stopping them, to switch back the next sheet P to the siding path 27 and to retain the next sheet P therein, as shown in FIG. 10A and FIG. 10B (S108). Further, at the time of performing the switchback transport of the next sheet P, the drive controller 53 restricts the cursors 28 from moving, during the period between the start time t1 of the switchback transport of the next sheet P by the transport rollers 22, and the arrival time t2 that the leading edge of the next sheet P conducted to the siding path 27 reaches the prespecified position S3, where the sheet P is kept from interfering with the cursor 28 (S109).

When the arrival time t2 is reached, the drive controller 53 of the sheet postprocessing apparatus 20 cancels the restriction on the movement of the cursors 28 (S110), and controls the transport driver 51, to move the auxiliary roller 29 away from the processing tray 25, and controls the cursor driver 52, to move the cursors 28 toward each other, so that the cursors 28 align the respective side edges of the sheets P on the processing tray 25 (S111). Then the drive controller 53 controls the stapling device 26, to perform the stapling operation on the trailing edge of the sheets P on the processing tray 25, and controls the transport driver 51, to move the upper delivery roller 23A downward, so as to be pressed against the lower delivery roller 23B as shown in FIG. 10C, so that the leading edges of the sheets P that have been subjected to the stapling operation are pinched between the delivery rollers 23A and 23B, to rotate the delivery rollers 23A and 23B, and to rotate the auxiliary roller 29 in the reverse direction, to deliver the sheets P subjected to the stapling operation from the processing tray 25 to the output tray 24 (S112).

When the cursors 28 are moved toward each other and align the respective side edges of the sheets P at S111, and the stapling operation is performed at S112, the upper delivery roller 23A is elevated and spaced from the lower delivery roller 23, as shown in FIG. 8B. When a second next sheet P is delivered in this state, since the clearance between the eaves-shaped guides 28A of the respective cursors 28 is narrower than the width of the sheet P, the second next sheet P is guided to the upper face of the eaves-shaped guide 28A of the cursors 28, and placed thereon. Then when the second next sheet is switched back by the transport rollers 22 from such state, the second next sheet P is smoothly delivered to the siding path 27, by sliding along the upper face of the eaves-shaped guide 28A of the cursor 28.

As described thus far, according to this embodiment, when the next sheet is switched back by the transport rollers 22, with the sheets P placed on the processing tray 25, the cursors 28 are restricted from moving, during the period between the start time t1 of the switchback transport of the next sheet P by the transport rollers 22, and the arrival time t2 that the leading edge of the next sheet P reaches the prespecified position S3, where the sheet P is kept from interfering with the cursor 28. Therefore, the next sheet P can be prevented from contacting at least one of the cursors 28 moving toward each other, thereby being switched back in a skewed posture, and from being retained in the siding path 27 in the skewed posture.

According to the foregoing embodiment, the cursors 28 align the respective side edges of the sheets P on the processing tray 25, when the number of sheets P delivered to the processing tray 25 reaches the designated number of sheets P to be processed. Instead, the cursors 28 may align the respective side edges of the sheets P, each time the sheet P is delivered to the processing tray 25. In this case also, when the number of sheets delivered to the processing tray 25 reaches the designated number of sheets P to be processed (YES at S104), the drive controller 53 decides whether a next sheet P, to be subjected to the stapling operation, is to be delivered (S105). When the next sheet P to be subjected to the stapling operation is not to be delivered (NO at S105), the drive controller 53 causes the cursors 28 to collectively align the respective side edges of the sheets P (S106), and delivers the sheets P subjected to the stapling operation to the output tray 24 (S107). In contrast, upon deciding that the next sheet P to be subjected to the stapling operation is to be delivered (YES at S105), the drive controller 53 retains the cursors 28 in the standby position, and rotates the transport rollers 22 to switch back the next sheet P to the siding path 27. Further, the drive controller 53 restricts the cursors 28 from moving, during the period between the start time t1 of the switchback transport of the next sheet P by the transport rollers 22, and the arrival time t2 that the leading edge of the next sheet P conducted to the siding path 27 reaches the prespecified position S3, where the sheet P is kept from interfering with the cursor 28 (S109). Then, when the arrival time t2 is reached, the drive controller 53 cancels the restriction on the movement of the cursors 28, and allows the cursors 28 to collectively align the respective side edges of the sheets P (S110),

In the case of the existing sheet postprocessing apparatuses, when the image forming operation on the next sheet and the transport thereof are suspended, while the sheets on the processing tray are being processed, the printing efficiency declines. Accordingly, the image forming operation on the next sheet and the transport thereof are continued while the sheets on the processing tray are being processed, and when a next sheet is delivered to the processing tray, the next sheet is switched back to the siding path located downstream of the processing tray in the sheet transport direction, and retained therein.

However, when at least one of the pair of cursors, which align the respective side edges of the sheets on the processing tray, is moved while the next sheet is switched back, the next sheet may contact the moving cursor, thus to be skewed.

The arrangement according to the foregoing embodiment has been conceived to cope with the mentioned drawback, and keeps the sheet to be switched back from contacting the cursor, being moved to align the respective side edges of the sheets on the processing tray.

The configurations and processings described in the embodiments, with reference to FIG. 1 to FIG. 11, are merely exemplary, and in no way intended to limit the disclosure to those configurations and processings.

While the present disclosure has been described in detail with reference to the embodiments thereof, it would be apparent to those skilled in the art that various changes and modifications may be made therein within the scope defined by the appended claims. What is claimed is;

1. A sheet postprocessing apparatus comprising:
a transport route through which a sheet is transported;
a processing tray that receives the sheet transported through the transport route;
a pair of cursors provided on respective sides of the processing tray, and opposed to each other in a direction orthogonal to a transport direction of the sheet;
a cursor moving device that reciprocatively moves the pair of cursors toward and away from each other, and brings the pair of cursors into contact with respective side edges of the sheet on the processing tray, thereby aligning the side edges of the sheet;
a switchback roller that switches back the sheet delivered to the processing tray;
a control device that includes a processor, and acts, when the processor executes a control program, as a controller that controls operation of the switchback roller and the cursor moving device; and
a siding path that receives, when the sheet delivered to the processing tray through the transport route is switched back by the switchback roller in a reverse direction, the sheet that has passed the processing tray in the reverse direction,
wherein the controller restricts the cursor moving device from moving the pair of cursors, during a period from start of switchback transport of the sheet, to a time that the sheet conducted toward the siding path reaches a prespecified position where the sheet is kept from interfering with the pair of cursors.

2. The sheet postprocessing apparatus according to claim 1,
wherein the controller calculates a transport time by dividing a distance between a position of a leading edge of the sheet at a start time of switchback transport of the sheet, and the prespecified position in the transport direction, by a speed of the switchback transport, and adopts a time point that the transport time has elapsed after the start time of the switchback transport of the sheet, as the arrival time.

3. The sheet postprocessing apparatus according to claim 2, further comprising a sheet sensor that detects a trailing edge of the sheet,
wherein the controller starts the switchback transport of the sheet, when the trailing edge of the sheet being transported is detected by the sheet sensor, and calculates the position of the leading edge of the sheet at the start time of the switchback transport of the sheet, on a basis of a detection position of the trailing edge by the sheet sensor, and a length of the sheet.

4. The sheet postprocessing apparatus according to claim 2,
wherein the arrival time is calculated in advance with respect to each of sheet sizes and stored in a memory, and the controller retrieves and acquires the transport time corresponding to the size of the sheet to be transported next, from the memory, instead of calculating the transport time.

5. The sheet postprocessing apparatus according to claim 1, further comprising an eaves-shaped guide provided on an upper edge of each of the pair of cursors, and configured to receive thereon the sheet transported to the sheet postprocessing apparatus, and guide the sheet switched back to the siding path.

6. An image processing system comprising:
an image forming apparatus that forms an image of a document on a sheet; and
the sheet postprocessing apparatus according to claim 1,
wherein, when a plurality of sheets are sequentially delivered from the image forming apparatus, the controller of the sheet postprocessing apparatus conducts the sheet delivered first to the processing tray through the transport route, conducts the sheet delivered next to the siding path by the switchback transport, and restricts the cursor moving device from moving the pair of cursors, during a period from start of the switchback transport of the sheet, to a time that the sheet conducted toward the siding path reaches a prespecified position where the sheet is kept from interfering with the pair of cursors.
